(19) United States
(12) Patent Application Publication
(10) Pub. No.: US 2019/0114553 A1
(43) Pub. Date: Apr. 18, 2019

(54) METHODS FOR MODELING DOGLEG SEVERITY OF A DIRECTION DRILLING OPERATION

(71) Applicant: HALLIBURTON ENERGY SERVICES, INC., Houston, TX (US)

(72) Inventor: Hossam GHARIB, Edmonton (CA)

(73) Assignee: HALLIBURTON ENERGY SERVICES, INC., Houston, TX (US)

(21) Appl. No.: 16/301,238

(22) PCT Filed: Jul. 18, 2016
(86) PCT No.: PCT/US2016/042861

§ 371 Date: Nov. 13, 2018

(51) Int. Cl. G06N 7/00; E21B 47/022; G05B 17/02

(52) U.S. Cl. CPC G06N 7/00; G05B 17/02; E21B 47/022

(57) ABSTRACT

A method of modeling dogleg severity (DLS) of a borehole that can be drilled using a drilling tool includes inputting a set of tool parameters and load parameters into a beam bending model which models bending effects of the drilling tool during a drilling operation, deriving an angular rotation of the drilling tool due to bending effects from the beam bending model, inputting the angular rotation into a contact model as a bend angle modifier, wherein the contact model generates a general curvature based the borehole contact points of the drilling tool, deriving a radius of the general curvature of the drilling tool from the contact model, inputting the radius into a DLS model, and deriving a DLS of the borehole from the DLS model.

### CONTEXT

Directional drilling is used to drill a well profile where control of the well bore trajectory is required to achieve an intended well profile. Directional drilling operations involve varying or controlling the direction of drilling a borehole to direct the tool and thus the borehole towards the desired target destination. For example, a directional drilling operation may be conducted to curve a borehole when the target pay zone cannot be reached from a land site vertically above it. Dogleg severity (DLS) is a measure of arc angle or curvature of the borehole. In directional well planning, the DLS may be modeled to control the direction and curvature of the borehole for location of a lateral section of the borehole at the pay zone.

### BRIEF DESCRIPTION OF THE DRAWINGS

For a detailed description of the embodiments of the invention, reference will now be made to the accompanying drawings in which:

FIG. 1 depicts a schematic view of a directional drilling tool, in accordance with one or more embodiments.

FIG. 2A is a diagram of a directional drilling tool with defined, low-side contact points, in accordance with example embodiments.

FIG. 2B illustrates a curvature of the contact points of the drilling tool of FIG. 2A, in accordance with example embodiments.

FIG. 3A is a diagram of a directional drilling tool with defined, low-side and high-side contact points, in accordance with example embodiments.

FIG. 3B illustrates curvatures of low-side and high-side contact points of the drilling tool of FIG. 3A, in accordance with example embodiments.

FIG. 4A is a diagram of a drilling tool with an undefined contact point, in accordance with example embodiments.

FIG. 4B illustrates curvatures of low-side and high-side contact points of the drilling tool of FIG. 4A, in accordance with example embodiments.

FIG. 5 illustrates positions of a directional drilling tool with no bending effects due to load and with bending effects due to load, in accordance with example embodiments.

FIG. 6 is a block diagram illustrating a method of modeling DLS with account bending effects, in accordance with example embodiments.

The drawings are for illustrative purposes and may not be drawn to scale.

### DETAILED DESCRIPTION

The present disclosure provides improved methods for modeling dogleg severity (DLS) as well as drilling a wellbore using the improved modeling methods. Specifically, the presently disclosed methods take into account different borehole contact points such as low-side as well as high-side contact points, undefined contact points in cases without an upper stabilizer, as well as bending effects of the tool under load. The presently disclosed methodology provides an accurate DLS model with relatively simplified modeling systems.

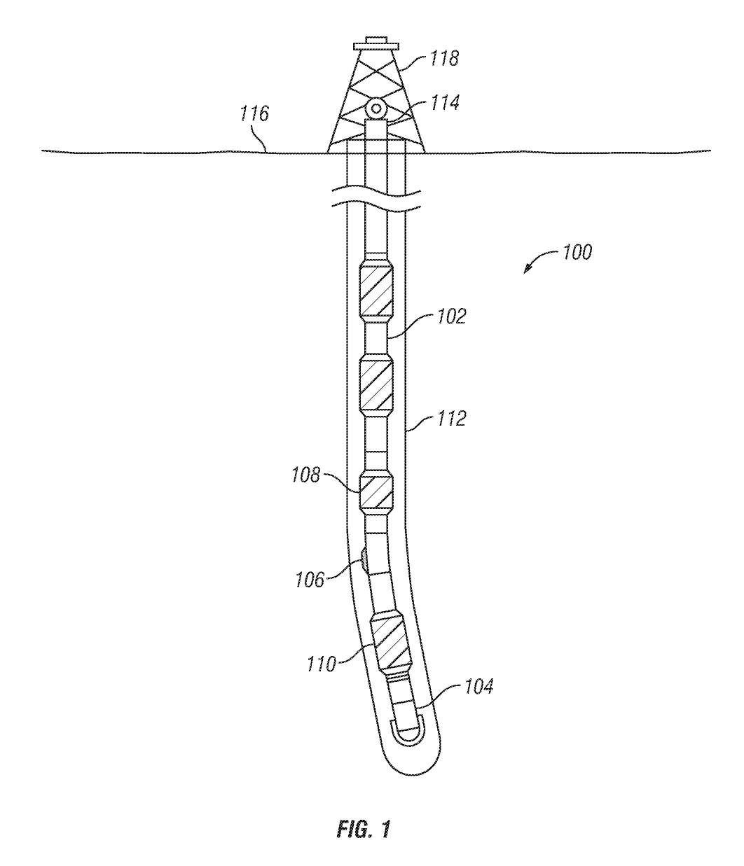

Turning now to the figures, FIG. 1 depicts a schematic view of a drill operation with a directional drilling tool 100, in accordance with one or more embodiments. The drilling tool 100 is suspended downhole from a rig 118 and is used to drill a directional borehole 112, such as a subsea well or a land well. However, the present disclosure is not limited to only drilling an oil well. The present disclosure also encompasses natural gas boreholes, other hydrocarbon boreholes, or boreholes in general. Further, the present disclosure may be used for the exploration and formation of geothermal boreholes intended to provide a source of heat energy instead of hydrocarbons.

The drilling tool 100 includes a motor 102 coupled to a drill bit 104. The motor 102 may be a mud motor which operates to rotate the drill bit 104 via drilling fluid being pumped therethrough. In some embodiments, a topdrive 114 located at the surface 116 is used to rotate the drill bit 104. The example drilling tool 100 further includes a bend region 106, an upper stabilizer 108, and a lower stabilizer 110. As the drilling tool 100 bends to drill a directional portion of a borehole, the tool 100 may contact the borehole at a plurality of points. Contact points may be at the bit 104, the bend region 106, the upper stabilizer 108, the lower stabilizer 110, or any combination thereof. In some embodiments, the contact points are defined, such as in the case with stabilizers. In some embodiments, one or more stabilizers may not be present, and the point(s) at which the drilling tool 100 will contact the borehole is undefined prior to the drilling operation. The present disclosure provides methods of modeling DLS in both of these cases. The present disclosure provides methods of modeling DLS based on contact points and methods of modeling DLS based on contact points and bending effects.

DLS Modeling Using Contact Points

As mentioned, there are two cases considered when modeling DLS using contact points in accordance with the present disclosure. The first case is one in which the relevant contact points are defined, such as by stabilizers. Within the first case, there are two subcases. In the first subcase, only low-side contact points are used in modeling DLS, low-side referring to the direction of gravity. In the second subcase, low-side and high-side contact points are used. In both cases, it is assumed that the drilling tool will always contact the low-side of the borehole. This assumption is considered acceptable, as the lower stabilizer point undergoes a reaction force along the low side of the borehole as a result of the bit side force. The contact point at the upper stabilizer can either be along the low side or high side of the borehole depending on the overall bending or configuration of the drilling tool. Thus, DLS modeling using contact points can be separated into the following cases and subcases:
Case 1—tool with defined contact points
   subcase I: low-side contact points
   subcase II: low-side and high-side contact points
Case 2—tool with an undefined contact point

Case 1, Subcase I

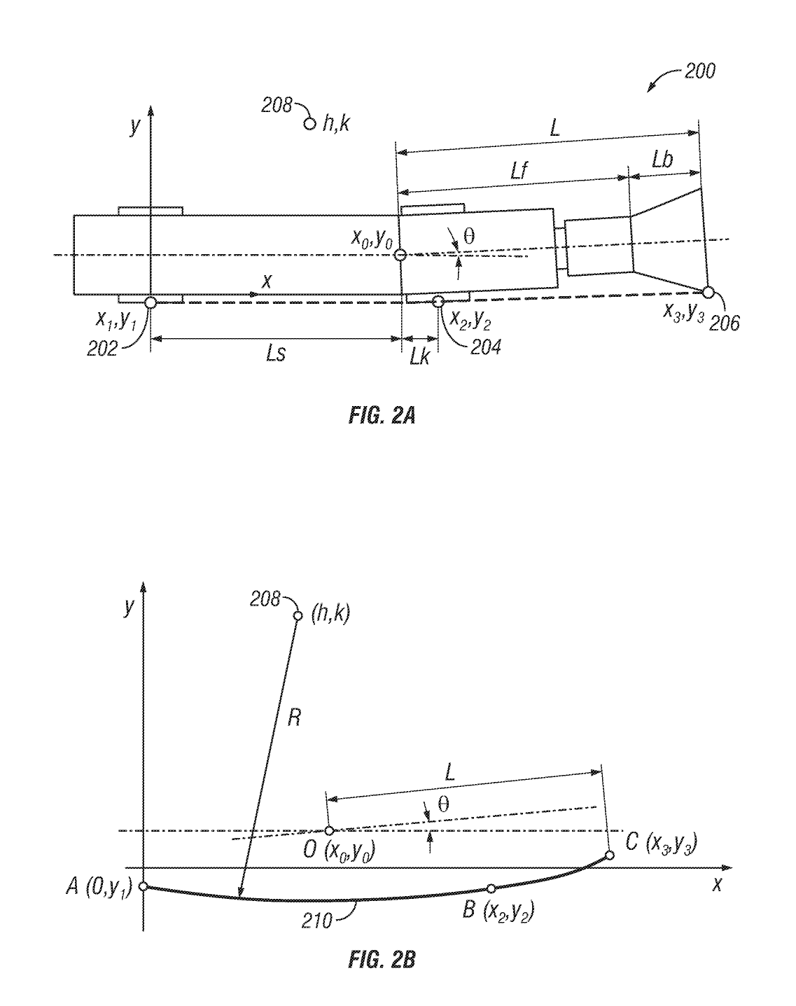

FIG. 2A is a diagram of a drilling tool 200 with defined, low-side contact points, in accordance with example embodiments. The drilling tool 200 is illustrated with reference to an x-y coordinate system.

Accordingly, a method of modeling DLS includes obtaining a plurality of contact points of the drilling tool 200. In this example, the drilling tool 200 includes three contact points: the upper stabilizer 202 (location defined as x₁, y₁), the lower stabilizer 204 (location defined as x₂,y₂), and the drill bit 206 ( location defined as x₃,y₃). In some embodiments, upper stabilizer 202 is defined at the origin.

The method further includes finding a general curvature 210 from the contact points 202, 204, 206, as illustrated in FIG. 2B. The solution of the curvature is defined by the center 208 of the circle passing through the three contact points 202, 204, 206. The center 208 is denoted as (h, k), and can be solved by eq. (1) and eq. (2).

$$\begin{matrix}h = \frac{[ \frac{{x}_{3}^{2} - {x}_{1}^{2} + {y}_{3}^{2} - {y}_{1}^{2}}{( {y}_{3} - {y}_{1} )} - \frac{{x}_{2}^{2} - {x}_{1}^{2} + {y}_{2}^{2} - {y}_{1}^{2}}{( {y}_{2} - {y}_{1} )} ]}{2 [ ( \frac{{x}_{3} - {x}_{1}}{{y}_{3} - {y}_{1}} ) - ( \frac{{x}_{2} - {x}_{1}}{{y}_{2} - {y}_{1}} ) ]} & eq . ( 1 ) \\ k = \frac{[ \frac{{x}_{2}^{2} - {x}_{1}^{2} + {y}_{2}^{2} - {y}_{1}^{2}}{( {y}_{2} - {y}_{1} )} - ( {x}_{2} - {x}_{1} ) h ]}{( {y}_{2} - {y}_{1} )} & eq . ( 2 )\end{matrix}$$

### Where:

x₁=0
y₁=(Dₜ−Dᵤₛ)/2
x₂=x₀+Lₖ cos(θ_{b})+(Dₖ/2)sin(θ_{b})=Distance between upper stabilizer and lower stabilizer
y₂=Dₜ/2+Lₖ sin(θ)−Dₖ/2 cos(θ)
x₀=Lₛ=Distance between upper stabilizer and focal point
y₀=Dₜ/2
x₃=x₀+L cos(θ)+(D_{b}/2)sin(θ)
y₃=Dₜ/2+L sin(θ)−(D_{b}/2)cos(θ)
θ=angular inclination of the bit from the focal point
θ_{b}=angular inclination of the lower stabilizer from the focal point (if not equal to θ)
L=Length from focal point to bit end along shaft axis
D_{b}=Diameter of the bit
Dₜ=Diameter of the tool
Dₖ=Diameter of the lower stabilizer

The method further includes finding a radius of the curvature, which can be derived from eq. (3).

R=\sqrt{h²+k²−2x₁h−2y₁k+x₁²+y₁²} eq. (3)

The method further includes inputting the radius into a DLS model, defined by eq. (4), the output of which is the DLS. The DLS is defined in degrees/100 feet.

$$DLS = \frac{[ 100 ]}{( R )} \times \frac{[ 180 ]}{( π )} \qquad eq . ( 4 )$$

Case 1, Subcase II

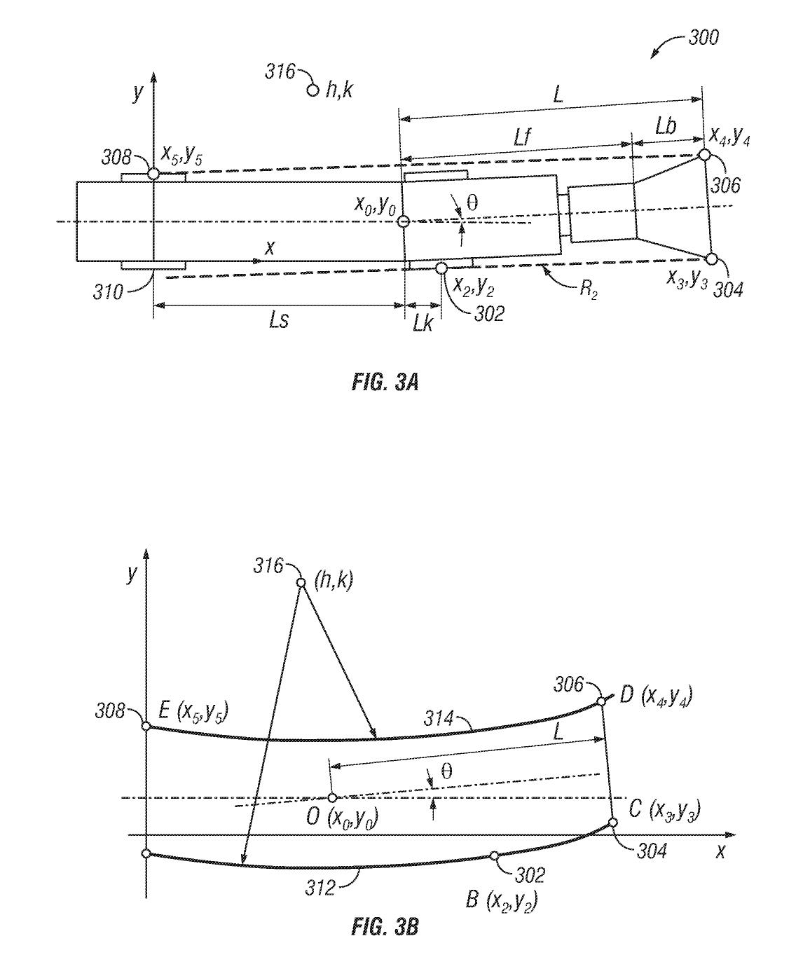

FIG. 3A is a diagram of a drilling tool 300 with defined, low-side and high-side contact points, in accordance with example embodiments. The drilling tool 300 is illustrated with reference to an x-y coordinate system.

Accordingly, a method of modeling DLS includes obtaining a plurality of contact points of the drilling tool 200. In this example, the drilling tool 300 includes four contact points: the low-side of the lower stabilizer 302 (location defined as x₂,y₂), the low-side of the drill bit 304 (location defined as x₃,y₃), the high-side of the drill bit 306 (location defined as x₄,y₄), and the high-side of the upper stabilizer 308 (location defined as x₅,y₅). In some embodiments, the low-side of the upper stabilizer 310 is defined at the origin.

The method further includes finding a general curvature defined by the contact points. However, in this subcase, the method includes finding two curvatures. FIG. 3B illustrates the two curvatures. A low-side curvature 312 is defined by a circle passing through the contact points 302, 304 on the low-side of the drilling tool 300. A high-side curvature 314 is defined be a circle passing through the contact points 306, 308 on the high-side of the drilling tool 300. The two curvatures 312, 314 share a common center point 316, (h, k), defined by eq. (5) and eq. (6).

$$\begin{matrix}h = \frac{[ \frac{{x}_{5}^{2} - {x}_{4}^{2} + {y}_{5}^{2} - {y}_{4}^{2}}{( {y}_{5} - {y}_{4} )} - \frac{{x}_{3}^{2} - {x}_{2}^{2} + {y}_{3}^{2} - {y}_{2}^{2}}{( {y}_{3} - {y}_{2} )} ]}{2 [ ( \frac{{x}_{5} - {x}_{4}}{{y}_{5} - {y}_{4}} ) - ( \frac{{x}_{3} - {x}_{2}}{{y}_{3} - {y}_{2}} ) ]} & eq . ( 5 ) \\ k = \frac{[ \frac{{x}_{3}^{2} - {x}_{2}^{2} + {y}_{3}^{2} - {y}_{2}^{2}}{2} - ( {x}_{3} - {x}_{2} ) h ]}{( {y}_{3} - {y}_{2} )} & eq . ( 6 )\end{matrix}$$

Where, in addition to the parameters defined above:
x₄=x₀+L cos(θ)−(D_{b}/2)sin(θ)
y₄=Dₜ/2+L sin(θ)+(D_{b}/2)cos(θ)
x₅=0
y₅=Dₜ/2+Dₛ/2=½(Dₜ+Dₛ)

The center point 316 (h, k) is then used to derive the radius of the low-side curvature 312 and the radius of the high-side curvature 314 using eq. (7) and eq. (8).

R₁=\sqrt{h²+k²−2x₄h−2y₄k+x₄²+y₄²} (eq. 7)

R₂=\sqrt{h²+k²−2x₂h−2y₂k+x₂²+y₂²} eq. (8)

An average of R₁ and R₂, R=(R₁+R₂)/2, is then used in the DLS model, eq. (4), to derive the DLS.

Case 2

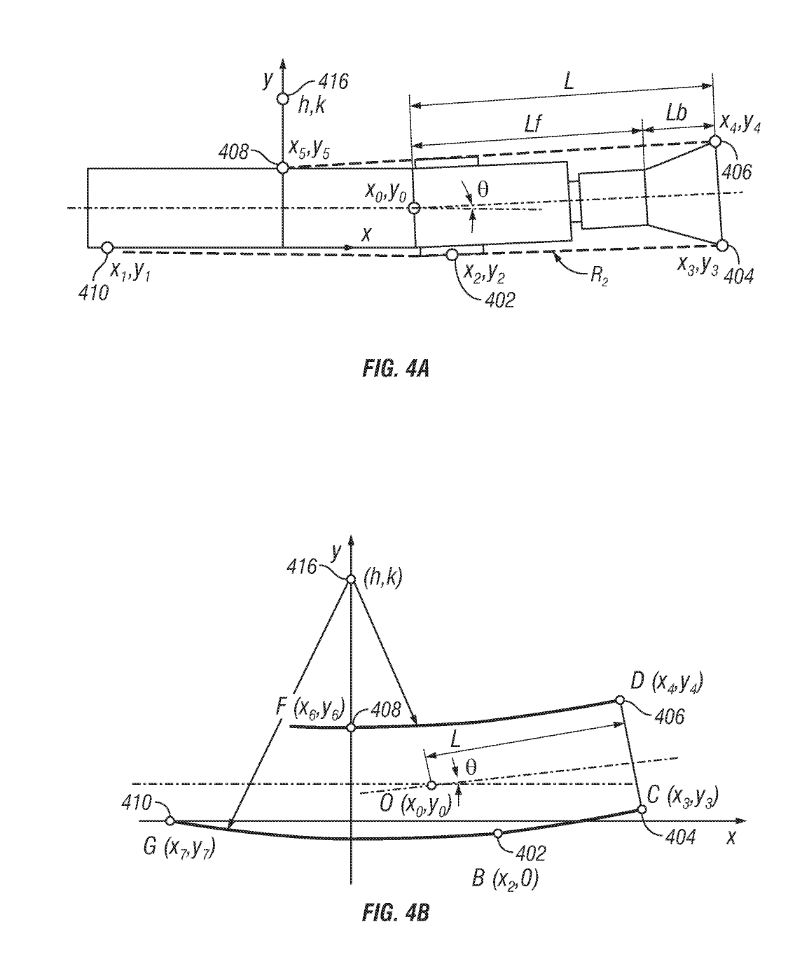

FIG. 4A is a diagram of a drilling tool 400 with an undefined contact point, in accordance with example embodiments. The drilling tool 400 is illustrated with reference to an x-y coordinate system. In this case, it is assumed that the drilling tool 400 has known contact points on both the low-side and high-side of the drilling tool 400 and an undefined contact point whose location is unknown a priori. Specifically, in this example, the known contact points include: the low-side of the lower stabilizer 402 (location defined as x₂,y₂), the low-side of the drill bit 404 (location defined as x₃,y₃), and the high-side of the drill bit 406 (location defined as x₄,y₄). In this case, there is also a tangent point 408, denoted as x₅,y₅, which is located on the high-side. The undefined contact point 410 is denoted as x₇,y₇.

Similar to case 1, subcase II, the method of modeling DLS includes finding the curvatures defined by the known low-side contact points 402, 404 and the high-side contact points 406, 408. It is assumed that x-position of the tangent point 408 is at 0 and the y-position of the tangent point 408 is the diameter of the tool.

x₆=0

y₆=Dₜ,

where Dₜ=tool diameter at tangent point

The locations of the remaining known contact points can be derived based on the position of the tangent point 408 and the tool parameters. FIG. 4B illustrates the low-side curvature 412 and the high-side curvature 414. The low-side curvature 412 is defined by a circle passing through the contact points 402, 404 on the low-side of the drilling tool 400. The high-side curvature 414 is defined by a circle passing through the contact points 406, 408 on the high-side of the drilling tool 400. The two curvatures 412, 414 share a common center point 416, (h, k), defined by eq. (9) and eq. (10).

$$\begin{matrix}h = 0 & eq . ( 9 ) \\ k = \frac{\frac{{x}_{3}^{2} - {x}_{2}^{2} + {y}_{3}^{2} - {y}_{2}^{2}}{2}}{2 ( {y}_{3} - {y}_{2} )} & eq . ( 10 )\end{matrix}$$

The center point 416 (h, k) is then used to derive the radius of the low-side curvature 412 and the radius of the high-side curvature 414 using eq. (7) and eq. (8). The two radii are then averaged and used in the DLS model, eq. (4), to derive the DLS.

The location of the previously undefined contact point 410 can be derived from eq. 11 and eq. 12. The location of the contact point 410 will be used in calculating bending effects of the tool.

$$\begin{matrix}{y}_{7} = \frac{{D}_{t} - {D}_{7}}{2} & eq . ( 11 ) \\ {x}_{7} = - \sqrt{{R}_{2}^{2} - {( {y}_{7} - k )}^{2}} & eq . ( 12 )\end{matrix}$$

where D₇=diameter of the drilling tool at y₇,x₇

DLS Modeling Using Contact Points and Bending Effects

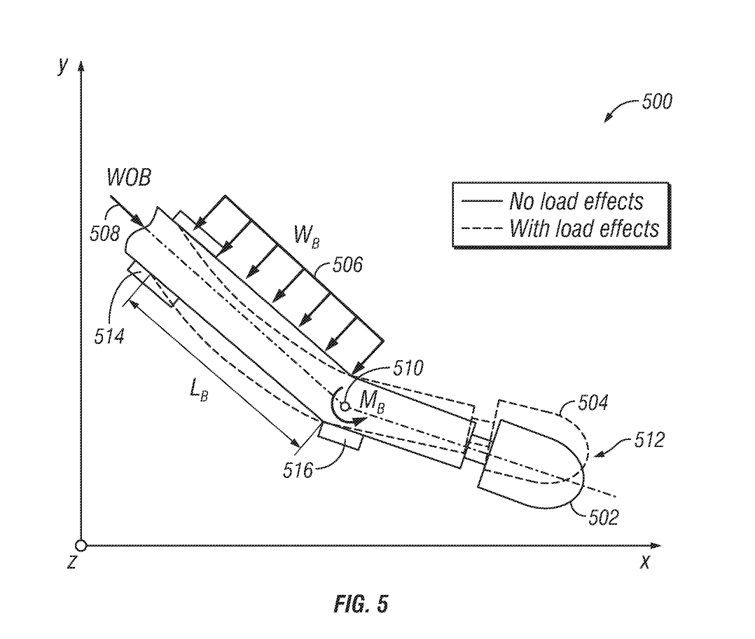

During an actual drilling operation, the drilling tool 100 typically experiences load, such as the self-weight of the drilling tool and the applied weight-on-bit (WOB). This weight may cause the drilling tool 100 to exhibit bending effects in addition to the intended bend angle of the drilling tool 100. Thus, the actual bend angle and dogleg of the drilling tool 100 during operation is affected. FIG. 5 illustrates the effects of load on a drilling tool 500, in accordance with example embodiments. Specifically, FIG. 5 illustrates positions of the drilling tool 500 with no bending effects due to load 502, and with bending effects due to load 504. Load 508 illustrates the applied WOB. Load 506 illustrates the projection of self-weight along a lateral side of the tool 500, which creates a side load applied on the tool 500. The loads 506, 508 generate a moment which causes angular rotation at a focal point 510 of the drilling tool 500. The angular rotation causes the bit 512 to change direction either by an increase or decrease in the bend angle, depending on low-side or high-side contact. Thus, methods of DLS modeling using contact points and bending effects takes this change in bend angle into account when modeling the DLS. Again, there are two cases, one with defined contact points and one in which there is at least one undefined contact point.

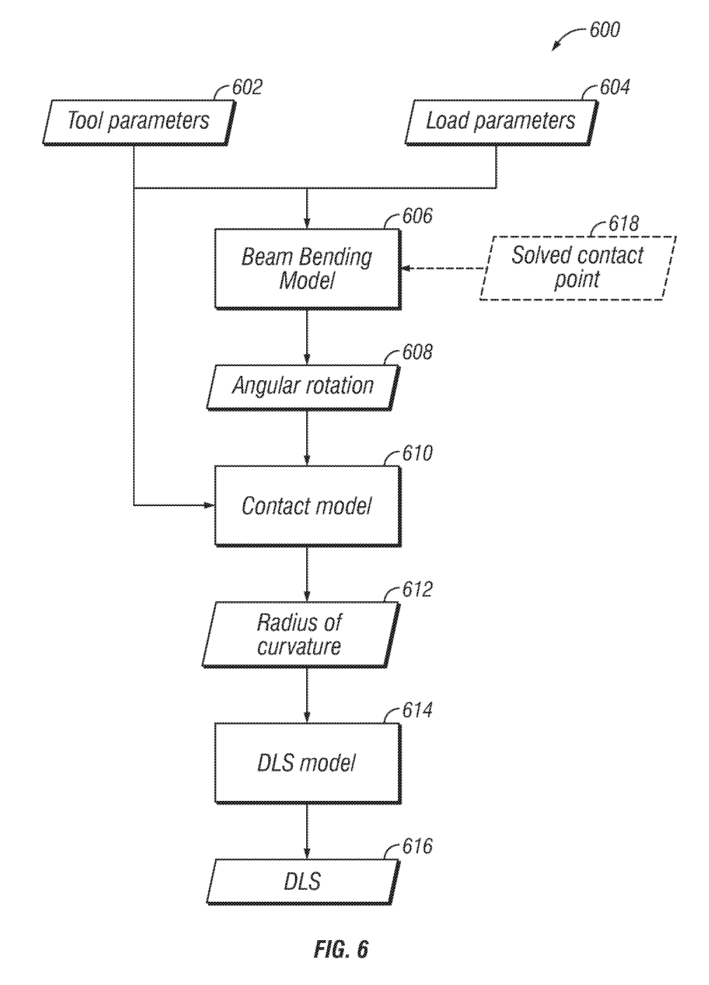

FIG. 6 is a block diagram 600 illustrating a method of modeling DLS into account bending effects, in accordance with example embodiments. The method includes inputting a set of tool parameters 602 and load parameters 604 into a beam bending model 606 which models bending effects of the drilling tool 500 during a drilling operation. The tool parameters 602 may include a diameter of a drill bit coupled to the drilling tool, a diameter of the drilling tool, a diameter of an upper stabilizer of the drilling tool, a diameter of a lower stabilizer of the drilling tool, a distance from a focal point of drilling tool to a bit box, a length of the drill bit, a distance between the upper stabilizer to the focal point, an angular inclination of the drill bit from the focal point, an angular inclination of the lower stabilizer from the focal point, or any subset thereof. The load parameters 604 comprise a density of the drilling tool material, a density of drilling fluid used, a cross-sectional area of the drilling tool, an area moment of inertia of the drilling tool, a weight-on-bit, a hole-inclination degree, or any subset thereof.

In the case of a drilling tool 500 with an undefined contact point, the undefined contact point 618 can be found through eqs. (9)-(12) as described above and used in the beam bending model 606.

The output of the beam bending model 606 is an angular rotation 608 caused by the load on the drilling tool 500. The beam-bending model 606 solves for the angular rotation 608 at the focal point 510, which is calculated by superimposing the effects of applied WOB and self-weight of the drilling tool 500 based on beam deflection behavior described by eq. 13.

$$\frac{{d}^{2} y}{{dx}^{2}} = \frac{M ( x )}{EI} \qquad eq . ( 13 )$$

### Where

E=Elastic modulus of the beam
I=Moment of inertia of the beam

The moment equation resulting from the applied WOB can be defined as eq. (14) and the moment resulting from distributed load (e.g., self-weight) can be defined as eq. (15). The distributed load includes effects of buoyancy and can be defined as eq. (16).

$$\begin{matrix}{M}_{1} ( x ) = \frac{{M}_{B} x}{{L}_{B}} + {M}_{B} {〈 x - a 〉}^{0} & eq . ( 1 ) \\ {M}_{2} ( x ) = \frac{{W}_{B} {L}_{B}}{2} x - \frac{{W}_{B}}{2} {x}^{2} & eq . ( 2 ) \\ {W}_{B} = ( ρ - m ) \times A & eq . ( 3 )\end{matrix}$$

### Where

ρ=Density of the beam (steel), lb/in³
m=Density of the mud, lb/in³
A=Cross-sectional area of the beam, in²
L_{b}=Distance between two contact points (e.g., upper stabilizer 514 and lower stabilizer 516), and a is the distance between the upper stabilizer 514 and a point of moment application, which can be anywhere along the length of the beam or at the lower stabilizer 516 due to WOB.

If the contact points of the drilling tool 500 are all defined, such as in the cases of FIGS. 2A and 3A, then the angular rotation 608 can be solved through eq. 17 and eq. 18. Specifically, the angular rotation 608 at the lower stabilizer is defined by eq. 18.

$$\begin{matrix}θ ( x ) = \frac{1}{EI} ( \begin{matrix}\frac{{M}_{B} {x}^{2}}{2 {L}_{B}} + \frac{{M}_{B}}{6 {L}_{B}} ( 2 {L}_{B}^{2} - 6 {L}_{B} a + 3 {a}^{2} ) - \\ {M}_{B} 〈 x - a 〉 + \frac{{W}_{B} {x}^{3}}{6} - \frac{{W}_{B} {L}_{B} {x}^{2}}{4} + \frac{{W}_{B} {L}_{B}^{3}}{24}\end{matrix} ) & eq . ( 4 ) \\ {θ}_{0} = \frac{{L}_{B}}{3 EI} ( {M}_{B} + \frac{{W}_{B} {L}_{B}^{2}}{8} ) & eq . ( 5 )\end{matrix}$$

Where y=0 and x=L_{b}, and Assuming α=L_{B} and solving θ at x=L.

If there is an undefined contact point on the drilling tool 500, such as in the cases of FIG. 4A, then the angular rotation 608 can be solved through eq. (19) and eq. (20)

$$\begin{matrix}θ ( x ) = \frac{1}{EI} ( \frac{{M}_{B} {x}^{2}}{2 {L}_{B}} - {M}_{B} 〈 x - a 〉 + \frac{{W}_{B} {L}_{B} {x}^{2}}{4} + \frac{{W}_{B} {x}^{3}}{6} ) & eq . ( 19 ) \\ {θ}_{0} = \frac{{L}_{B}}{2 EI} ( {M}_{B} + \frac{{W}_{B} {L}_{B}^{2}}{6} ) & eq . ( 6 )\end{matrix}$$

Considering that the boundary condition is θ=0 at x=0 and assuming α=L_{B} and solving θ(x) at x=L_{B}. The angular rotation 608 is then input into in a contact model 610 as a modified bend angle.

If the contact points of the drilling tool 500 are only low-side contact points, the contact model 610 can be expressed as eq. (1)-eq. (3), in which angular inclination, θ, is increased or decreased by angular rotation 608, θ₀. If the contact points of the drilling tool are low-side and high-side contact points, the contact model 610 can be expressed as eq. (5)-eq. (8), in which angular inclination, θ, is increased or decreased by angular rotation 608, θ₀.

The contact model 610 generates a curvature based on the borehole contact points of the drilling tool 500 from which a radius is derived 612. In the case of the low-side and high-side contact points, the radius is the average of the low-side radius and the high-side radius. The radius 612 is then used in the DLS model 616, expressed as eq. (4), to calculate a DLS 616.

The above described methods of modeling DLS can be used for a number of applications, including during the tool design process as well as for planning a well drilling operation. For example, during the tool design process, theoretical tool parameters and expected load parameters can be used to determine a DLS model, which is used to confirm whether a tool having such parameters can provide the desired DLS range and/or other capabilities. After confirming, a drilling tool having such parameters can be manufactured or chosen for a drilling operation. In another example, the DLS model can be used for planning the drilling operation of a well. The well is then drilled according to the plan.

In addition to the embodiments described above, many examples of specific combinations are within the scope of the disclosure, some of which are detailed below:

### Example 1

A method of modeling dogleg severity (DLS) of a borehole that can be formed from a drilling operation using a drilling tool with defined borehole contact points, comprising:
inputting a set of tool parameters and load parameters into a beam bending model which models bending effects of the drilling tool during a drilling operation;
deriving an angular rotation of the drilling tool due to bending effects from the beam bending model;
inputting the angular rotation into a contact model as a modified bend angle;
deriving a radius of a general curvature of the drilling tool based on the borehole contact points from the contact model;
inputting the radius into a DLS model; and
deriving a DLS of the borehole from the DLS model.

### Example 2

The method of claim 1, further comprising providing the drilling tool.

### Example 3

The method of claim 2, further comprising drilling the borehole using the drilling tool.

### Example 4

The method of claim 2, further comprising building the drilling tool according to the set of tool parameters.

Example 5

The method of claim 1, wherein the tool parameters comprise a diameter of a drill bit coupled to the drilling tool, a diameter of the drilling tool, a diameter of the drilling tool at a first contact point, a diameter of the drilling tool at a second contact point, a distance from a focal point of drilling tool to a bit box, a length of the drill bit, a distance between the first contact point to the focal point, an angular inclination of the drill bit from the focal point, an angular inclination of the second contact point from the focal point, or any subset thereof.

### Example 6

The method of claim 1, wherein the load parameters comprise a density of the drilling tool material, a density of drilling fluid used, a cross-sectional area of the drilling tool, an area moment of inertia of the drilling tool, a weight-on-bit, a hole-inclination degree, or any subset thereof.

### Example 7

The method of claim 1, wherein the contact model includes a set of low-side contact points.

### Example 8

The method of claim 1, wherein the contact model includes a set of low-side and high-side contact points.

### Example 9

The method of claim 1, wherein the DLS model defines DLS as a function of the radius.

### Example 10

The method of claim 8, wherein:
generating the general curvature comprises:
   determining a first curvature defined by the center point of a first circle passing through contact points on the low-side of the drilling tool; and
   determining a second curvature define by the center point of a second circle passing through contact points on the high-side of the drilling tool; and
deriving the radius of the general curvature comprises:
   determining a first radius of the first curvature;
   determining a second radius of the second curvature; and
   determining the average of the first and second radii.

### Example 11

A method of modeling dogleg severity (DLS) of a borehole that can be formed from a drilling operation using a drilling tool with an undefined contact point, comprising:
defining a first contact point of the drilling tool, wherein the first contact point is the previously undefined contact point;
determining a length between the first contact point and a focal point of the drilling tool;
inputting a set of tool parameters and load parameters into a beam bending model which models bending effects of the drilling tool during a drilling operation, wherein the set of tool parameters comprises the length between the first contact point and the focal point;
deriving an angular rotation of the drilling tool due to bending effects from the beam bending model;
inputting the angular rotation and into a contact model as a modified bend angle;
deriving a radius of a general curvature of the drilling tool based on the borehole contact points from the contact model;
inputting the radius into a DLS model; and
deriving a DLS of the borehole from the DLS model.

### Example 12

The method of claim 11, further comprising providing the drilling tool.

### Example 13

The method of claim 12, further comprising drilling the borehole using the drilling tool.

### Example 14

The method of claim 12, further comprising building the drilling tool according to the set of tool parameters.

### Example 15

The method of claim 11, wherein defining the first contact point comprises:
determining the center point of a circle defined by a plurality of known contact points;
determining a radius of the circle; and
determining the first contact point from the radius of the circle and a diameter of the drilling tool.

### Example 16

The method of claim 11, wherein the tool parameters further comprise a diameter of a drill bit coupled to the drilling tool, a diameter of the drilling tool, a diameter of the drilling tool at the first contact point, a diameter the drilling tool at a second contact point, a distance from a focal point of drilling tool to a bit box, a length of the drill bit, an angular inclination of the drill bit from the focal point, an angular inclination of the second contact point from the focal point, or any subset thereof.

### Example 17

The method of claim 11, wherein the load parameters comprise a density of the drilling tool material, a density of drilling fluid used, a cross-sectional area of the drilling tool, an area moment of inertia of the drilling tool, a weight-on-bit, a hole-inclination degree, or any subset thereof.

### Example 18

The method of claim 11, wherein the DLS model defines DLS as a function of the radius.

### Example 19

The method of claim 11, wherein:
finding the general curvature comprises:
   finding a first curvature defined by the center point of a first circle passing through contact points on the low-side of the drilling tool; and
   finding a second curvature define by the center point of a second circle passing through contact points on the high-side of the drilling tool; and
deriving the radius of the general curvature comprises:
   calculating a first radius of the first curvature;
   calculating a second radius of the second curvature; and
   calculating the average of the first and second radii.

### Example 20

A method of modeling dogleg severity (DLS) of a borehole that can be formed using a drilling tool, comprising:
obtaining contact points of the drilling tool relative to an origin defined on the tool body;
determining a radius of a general curvature formed from the contact points;
inputting the radius into a DLS model; and
calculating the DLS of the borehole.

### Example 21

The method of claim 20, wherein the DLS model defines DLS as a function of the radius.

### Example 22

The method of claim 20, wherein the contact points are on a low-side of the drilling tool, and the general curvature is defined by a center point of a circle passing through the contact points.

### Example 23

The method of claim 20, wherein the contact points are on a low-side of the drilling tool and a high-side of the drilling tool.

### Example 24

The method of claim 23, wherein finding the general curvature comprises:
finding a first curvature defined by the center point of a first circle passing through contact points on the low-side of the drilling tool; and
finding a second curvature define by the center point of a second circle passing through contact points on the high-side of the drilling tool.

### Example 25

The method of claim 24, wherein determining the radius of the general curvature comprises:
determining a first radius of the first curvature;
determining a second radius of the second curvature; and
determining the average of the first and second radii.

### Example 26

The method of claim 20, further comprising finding a previously undefined contact point of the drilling tool using the general curvature.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

What is claimed is:

1. A method of modeling dogleg severity (DLS) of a borehole that can be formed from a drilling operation using a drilling tool with defined borehole contact points, comprising:
inputting a set of tool parameters and load parameters into a beam bending model which models bending effects of the drilling tool during a drilling operation;
deriving an angular rotation of the drilling tool due to bending effects from the beam bending model;
inputting the angular rotation into a contact model as a modified bend angle;
deriving a radius of a general curvature of the drilling tool based on the borehole contact points from the contact model;
inputting the radius into a DLS model; and
deriving a DLS of the borehole from the DLS model.

2. (canceled)

3. (canceled)

4. The method of claim 1, further comprising providing the drilling tool, building the drilling tool according to the set of tool parameters, and drilling the borehole using the drilling tool.

5. The method of claim 1, wherein the tool parameters comprise a diameter of a drill bit coupled to the drilling tool, a diameter of the drilling tool, a diameter of the drilling tool at a first contact point, a diameter of the drilling tool at a second contact point, a distance from a focal point of drilling tool to a bit box, a length of the drill bit, a distance between the first contact point to the focal point, an angular inclination of the drill bit from the focal point, an angular inclination of the second contact point from the focal point, or any subset thereof.

6. The method of claim 1, wherein the load parameters comprise a density of the drilling tool material, a density of drilling fluid used, a cross-sectional area of the drilling tool, an area moment of inertia of the drilling tool, a weight-on-bit, a hole-inclination degree, or any subset thereof.

7. (canceled)

8. The method of claim 1, wherein the contact model includes a set of low-side contact points, high-side contact points, or combination thereof.

9. The method of claim 1, wherein the DLS model defines DLS as a function of the radius.

10. The method of claim 8, wherein:
generating the general curvature comprises:
determining a first curvature defined by the center point of a first circle passing through contact points on the low-side of the drilling tool; and
determining a second curvature define by the center point of a second circle passing through contact points on the high-side of the drilling tool; and
deriving the radius of the general curvature comprises:
determining a first radius of the first curvature;
determining a second radius of the second curvature; and
determining the average of the first and second radii.

11. A method of modeling dogleg severity (DLS) of a borehole that can be formed from a drilling operation using a drilling tool with an undefined contact point, comprising:
defining a first contact point of the drilling tool, wherein the first contact point is the previously undefined contact point;
determining a length between the first contact point and a focal point of the drilling tool;
inputting a set of tool parameters and load parameters into a beam bending model which models bending effects of the drilling tool during a drilling operation, wherein the set of tool parameters comprises the length between the first contact point and the focal point;
deriving an angular rotation of the drilling tool due to bending effects from the beam bending model;
inputting the angular rotation and into a contact model as a modified bend angle;
deriving a radius of a general curvature of the drilling tool based on the borehole contact points from the contact model;
inputting the radius into a DLS model; and
deriving a DLS of the borehole from the DLS model.

12. (canceled)

13. (canceled)

14. The method of claim 11, further comprising providing the drilling tool, building the drilling tool according to the set of tool parameters, and drilling the borehole using the drilling tool.

15. The method of claim 11, wherein defining the first contact point comprises:
determining the center point of a circle defined by a plurality of known contact points;
determining a radius of the circle; and
determining the first contact point from the radius of the circle and a diameter of the drilling tool.

16. The method of claim 11, wherein the tool parameters further comprise a diameter of a drill bit coupled to the drilling tool, a diameter of the drilling tool, a diameter of the drilling tool at the first contact point, a diameter the drilling tool at a second contact point, a distance from a focal point of drilling tool to a bit box, a length of the drill bit, an angular inclination of the drill bit from the focal point, an angular inclination of the second contact point from the focal point, or any subset thereof.

17. The method of claim 11, wherein the load parameters comprise a density of the drilling tool material, a density of drilling fluid used, a cross-sectional area of the drilling tool, an area moment of inertia of the drilling tool, a weight-on-bit, a hole-inclination degree, or any subset thereof.

18. The method of claim 11, wherein the DLS model defines DLS as a function of the radius.

19. The method of claim 11, wherein:
finding the general curvature comprises:
finding a first curvature defined by the center point of a first circle passing through contact points on the low-side of the drilling tool; and
finding a second curvature define by the center point of a second circle passing through contact points on the high-side of the drilling tool; and
deriving the radius of the general curvature comprises:
calculating a first radius of the first curvature;
calculating a second radius of the second curvature; and
calculating the average of the first and second radii.

20. A method of modeling dogleg severity (DLS) of a borehole that can be formed using a drilling tool, comprising:
obtaining contact points of the drilling tool relative to an origin defined on the tool body;
determining a radius of a general curvature formed from the contact points;
inputting the radius into a DLS model; and
calculating the DLS of the borehole.

21. The method of claim 20, wherein the DLS model defines DLS as a function of the radius.

22. The method of claim 20, wherein the contact points are on a low-side of the drilling tool, and the general curvature is defined by a center point of a circle passing through the contact points.

23. The method of claim 20, wherein the contact points are on a low-side of the drilling tool and a high-side of the drilling tool.

24. The method of claim 23, wherein finding the general curvature comprises:
finding a first curvature defined by the center point of a first circle passing through contact points on the low-side of the drilling tool; and
finding a second curvature define by the center point of a second circle passing through contact points on the high-side of the drilling tool.

25. The method of claim 24, wherein determining the radius of the general curvature comprises:
determining a first radius of the first curvature;
determining a second radius of the second curvature; and
determining the average of the first and second radii.

26. The method of claim 20, further comprising finding a previously undefined contact point of the drilling tool using the general curvature.
